(19) United States
(12) Patent Application Publication
(10) Pub. No.: US 2026/0302206 A1
(43) Pub. Date: Oct. 1, 2026

(54) CATHODE ACTIVE MATERIAL, BATTERY, AND BATTERY SYSTEM

(71) Applicant: TOYOTA JIDOSHA KABUSHIKI KAISHA, Tolyota-shi (JP)

(72) Inventors: Hiroko KUWATA, Sunto-gun (JP); Ryosuke Shibata, Susono-shi (JP)

(73) Assignee: TOYOTA JIDOSHA KABUSHIKI KAISHA, Tolyota-shi (JP)

(21) Appl. No.: 19/459,454

(22) Filed: Jan. 26, 2026

(30) Foreign Application Priority Data
Mar. 25, 2025 (JP) 2025-050039

(51) Int. Cl. H01M 4/525; H01M 10/054

(52) U.S. Cl. CPC H01M 4/525; H01M 10/054

(57) ABSTRACT

A cathode active material of the present disclosure includes an Na-containing transition metal oxide. The Na-containing transition metal oxide has an O3 structure. The Na-containing transition metal oxide has a chemical composition represented by NaₓNi_{y}Mn_{(1-y-z)}M_{z}O₂ (0.97≤x≤1.09, 0<y<1.000, and 0<z<0.120). M is one or more elements selected from Al, Fe, Mg, Mo, Ti, V, Cr, Cu, Zn, Ga, Se, Zr, Sn, Te, Hf, and Re.

### CROSS-REFERENCE TO RELATED APPLICATION

This application claims priority to Japanese Patent Application No. 2025-050039 filed on Mar. 25, 2025. The disclosure of the above-identified application, including the specification, drawings, and claims, is incorporated by reference herein in its entirety.

### BACKGROUND

### 1. Technical Field

The present disclosure relates to cathode active materials, batteries, and battery systems.

### 2. Description of Related Art

WO 2014/156765 discloses, as a cathode active material for a sodium secondary battery, a composite metal oxide having an α-NaFeO₂ crystal structure and having a prescribed chemical composition. Japanese Unexamined Patent Application Publication No. 2006-179473 (JP 2006-179473 A) discloses, as a cathode active material for a non-aqueous electrolyte secondary battery, a composite oxide mainly containing sodium, nickel, and a tetravalent metal and having a hexagonal crystal structure.

### SUMMARY

Conventional cathode active materials still have room for improvement in terms of capacity retention when charge-discharge cycling is performed at high charging potentials.

In order to address this issue, the present disclosure provides the following aspects.

### First Aspect

A cathode active material including an Na-containing transition metal oxide, wherein:
the Na-containing transition metal oxide has an O3 structure;
the Na-containing transition metal oxide has a chemical composition represented by

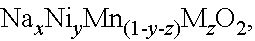

where 0.97≤x≤1.09, 0<y<1.000, and 0<z<0.120; and
M is one or more elements selected from Al, Fe, Mg, Mo, Ti, V, Cr, Cu, Zn, Ga, Se, Zr, Sn, Te, Hf, and Re.

### Second Aspect

The cathode active material according to the first aspect, wherein
M is one or more elements selected from Al, Fe, Mg, and Mo.

### Third Aspect

The cathode active material according to the first aspect, wherein
M is one or more elements selected from Al, Fe, and Mg.

### Fourth Aspect

A battery including a cathode active material layer, an electrolyte layer, and an anode active material layer, wherein
the cathode active material layer contains the cathode active material according to any one of the first to third aspects.

### Fifth Aspect

A battery system including a battery and a control unit, wherein:
the battery is the battery according to the fourth aspect; and
the control unit is configured to control charging of the battery such that a cathode potential at a charge cutoff potential of the battery becomes 4.0 V or more versus Na/Na⁺.

The cathode active material of the present disclosure can maintain excellent capacity even when charge-discharge cycling is performed at high charging potentials.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an issue in a conventional cathode active material;

FIG. 2 is a schematic diagram illustrating a mechanism by which a cathode active material according to an embodiment addresses the issue;

FIG. 3 schematically shows an example of the configuration of a battery;

FIG. 4 schematically shows an example of the configuration of a battery system;

FIG. 5 shows X-ray diffraction patterns of Example 1-1 and Comparative Example 1; and

FIG. 6 shows X-ray diffraction patterns of Example 1-1 and Comparative Example 1.

### DETAILED DESCRIPTION OF EMBODIMENTS

Hereinafter, embodiments of a cathode active material, a battery, and a battery system according to the present disclosure will be described. However, the cathode active material, the battery, and the battery system according to the present disclosure are not limited to the embodiments described below.

### 1. Cathode Active Material

A cathode active material according to one embodiment includes an Na-containing transition metal oxide. The Na-containing transition metal oxide has an O3 structure. The Na-containing transition metal oxide has a chemical composition represented by NaₓNi_{y}Mn_{(1-y-z)}M_{z}O₂ (0.97≤x≤1.09, 0<y<1.000, and 0<z<0.120). M is one or more elements selected from Al, Fe, Mg, Mo, Ti, V, Cr, Cu, Zn, Ga, Se, Zr, Sn, Te, Hf, and Re.

### 1.1 Crystal Structure

In the present embodiment, the Na-containing transition metal oxide contained in the cathode active material has at least an O3 structure as its crystal structure. The Na-containing transition metal oxide may have, in addition to the O3 structure, a crystal structure other than the O3 structure. The Na-containing transition metal oxide may have the O3 structure as its main phase. The Na-containing transition metal oxide may have no crystal structure other than the O3 structure identified in its X-ray diffraction pattern.

### 1.2 Chemical Composition

The Na-containing transition metal oxide according to the present embodiment has a chemical composition represented by NaₓNi_{y}Mn_{(1-y-z)}M_{z}O₂ (0.97≤x≤1.09, 0<y<1.000, and 0<z<0.120). M is one or more elements selected from Al, Fe, Mg, Mo, Ti, V, Cr, Cu, Zn, Ga, Se, Zr, Sn, Te, Hf, and Re. That is, the Na-containing transition metal oxide according to the present embodiment contains Na, Ni, M, and O, and optionally contains Mn.

In the above chemical composition, x is 0.97 or more, and may be 0.98 or more, 0.99 or more, or 1.00 or more, and x is 1.09 or less, and may be 1.08 or less, 1.07 or less, 1.06 or less, or 1.05 or less. Furthermore, y is greater than 0, and may be 0.100 or more, 0.200 or more, 0.300 or more, 0.400 or more, or 0.500 or more, and y is less than 1.000, and may be 0.900 or less, 0.800 or less, 0.700 or less, 0.600 or less, or 0.500 or less. Furthermore, z is greater than 0, and may be 0.010 or more, 0.020 or more, 0.030 or more, 0.040 or more, 0.050 or more, or 0.060 or more, and z is less than 0.120, and may be 0.110 or less, 0.100 or less, 0.090 or less, 0.080 or less, 0.070 or less, 0.060 or less, 0.040 or less, 0.030 or less, or 0.020 or less. The composition of O is approximately 2, but may not be exactly 2.0 and may be indefinite.

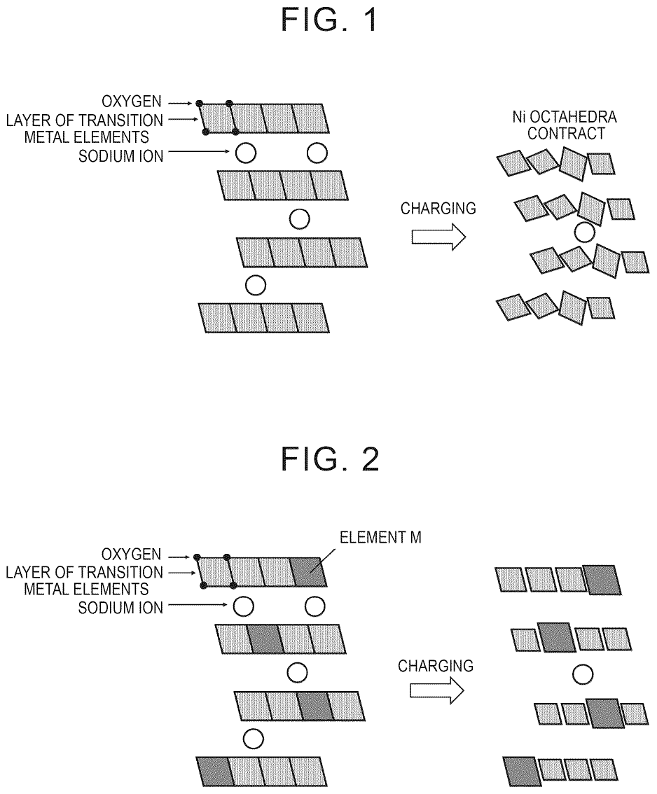

An Na-containing transition metal oxide having an O3 structure has a layered structure in which Na ions are present between layers of transition metal elements. In conventional Na-containing transition metal oxides having an O3 structure, at high potentials (for example, 4.0 V or more vs. Na/Na⁺), the valence of Ni changes, resulting in a change in its ionic radius (Ni²⁺: 0.69 Å, Ni⁴⁺: 0.48 Å), which causes collapse of the transition metal layers and narrowing of the sodium-ion conduction paths. In conventional Na-containing transition metal oxides, when charge-discharge cycling is performed at high potentials, the collapsed transition metal layers as shown in FIG. 1 do not return to their original state, and the capacity as a cathode active material tends to gradually decrease. That is, conventional Na-containing transition metal oxides having an O3 structure still have room for improvement in terms of capacity retention when charge-discharge cycling is performed at high charging potentials.

In contrast, in the above examples, the Na-containing transition metal oxide contains an element M that hardly contributes to redox. The ionic radii of the above-listed elements M are all larger than 0.48 Å and less than 0.60 Å, are larger than the ionic radius of Ni⁴⁺ (0.48 Å), and are close to the ionic radius of Mn⁴⁺ (0.53 Å). Therefore, the element M is present in the layers of transition metal elements in the O3 structure. Since the element M that hardly contributes to redox is contained in the layers of transition metal elements, the element M functions as a pillar, and, as shown in FIG. 2, the shape of the transition metal layers is more likely to be maintained even at high potentials, the reversibility is improved, and the capacity is more likely to be retained. In particular, when the element M is one or more elements selected from Al, Fe, Mg, and Mo, and especially when the element M is one or more elements selected from Al, Fe, and Mg, the capacity is even more likely to be retained.

### 1.3 Others

As described above, in the Na-containing transition metal oxide according to the present embodiment, the layers of transition metal elements are stabilized by the element M, making it easier to maintain wide Na-ion conduction paths. A cathode active material containing such an Na-containing transition metal oxide can maintain excellent capacity even when charge-discharge cycling is performed at high charging potentials. The cathode active material according to the present embodiment may be formed of the above 20 Na-containing transition metal oxide, or may contain other (additional) components in addition to the above Na-containing transition metal oxide. From the viewpoint of further enhancing the above effects, the proportion of the other components in the entire cathode active material may be small. For example, when the total amount of the cathode active material is taken as 100 mass %, the content of the above Na-containing transition metal oxide may be 50 mass % or more and 100 mass % or less, 60 mass % or more and 100 mass % or less, 70 mass % or more and 100 mass % or less, 80 mass % or more and 100 mass % or less, 90 mass % or more and 100 mass % or less, 95 mass % or more and 100 mass % or less, or 99 mass % or more and 100 mass % or less. The cathode active material according to one embodiment may be, for example, a cathode active material used in a sodium-ion battery.

The cathode active material may be in the form of solid particles, hollow particles, or particles having voids. The size of the cathode active material is not particularly limited. For example, the average particle size of the cathode active material may be 0.1 μm or more and 10 μm or less, 1.0 μm or more and 8.0 μm or less, or 2.0 μm or more and 6.0 μm or less. The term “average particle size” as used herein refers to the particle size (D50, median diameter) at a cumulative value of 50% in the volume-based particle size distribution, as measured by a laser diffraction/scattering method.

### 2. Method for Producing Cathode Active Material

The above Na-containing transition metal oxide having an O3 structure can be produced by, for example, the following method. That is, a method for producing an Na-containing transition metal oxide having an O3 structure according to one embodiment includes:
S1: obtaining a precursor containing Ni and Mn by coprecipitation;
S2: mixing the precursor with an Na source and an element M source to obtain a mixture; and
S3: calcining the mixture to obtain an Na-containing transition metal oxide having an O3 structure.

### 2.1 Preparation of Precursor

In S1, a precursor containing Ni and Mn is obtained by coprecipitation. In S1, it is preferable to obtain a precursor having a low melting point. For example, the precursor obtained by coprecipitation in S1 may be a composite hydroxide containing Ni and Mn. By obtaining a precursor having a low melting point (for example, a composite hydroxide containing Ni and Mn) in S1, the calcination temperature in S3 described later can be lowered, resulting in well-aligned layers of transition metal elements and reduced cation mixing in the resulting Na-containing transition metal oxide having an O3 structure. The precursor may take various forms. For example, the precursor may be in the form of particles. In S1, for example, an ion source capable of forming a precipitate with transition metal ions in an aqueous solution may be used together with an Ni compound and an Mn compound, and a composite hydroxide serving as the above precursor may be obtained by coprecipitation. The “ion source capable of forming a precipitate with transition metal ions in an aqueous solution” may be, for example, sodium hydroxide. The “Ni compound” may be a salt containing Ni, for example, a sulfate. The “Mn compound” may be a salt containing Mn, for example, a sulfate. In S1, for example, a first aqueous solution in which sodium hydroxide is dissolved and a second aqueous solution in which the Ni compound and the Mn compound are dissolved are added dropwise and mixed to precipitate, as the precursor, a composite hydroxide containing Ni and Mn. At this time, various sodium compounds may be added as a base, and an aqueous ammonia solution or the like may be added to adjust the basicity.

### 2.2 Preparation of Mixture

In S2, the precursor obtained in step S1, an Na source, and an element M source are mixed to obtain a mixture. In the present embodiment, it is preferable to use an Na source having a low melting point. For example, the Na source that is mixed with the precursor in S2 may have a melting point of 460° C. or less. Examples of Na sources having such a low melting point include sodium hydroxide and molten salts containing Na (molten salts obtained by mixing and melting two or more types of sodium salts). By using an Na source having a low melting point as the Na source in S2, the calcination temperature in S3 can be lowered, resulting in well-aligned layers of transition metal elements and reduced cation mixing in the resulting Na-containing transition metal oxide having an O3 structure. The Na source may take various forms. For example, the Na source may be in the form of particles. The element M source may be, for example, a salt of the element M, or may be a compound other than a salt such as an oxide or hydroxide of the element M. In one embodiment, the element M source may be a nitrate of the element M or may be an oxide of the element M. In S2, the mixture may be obtained by, for example, mixing the precursor, the Na source, and the element M source by mixing means. The mixing means is not particularly limited. For example, the precursor, the Na source, and the element M source may be manually mixed using a mortar or the like, or may be mechanically mixed using a mixer or the like. In S2, the mixing ratio of the precursor, the Na source, and the element M source may be adjusted, in consideration of the amount of Na that will be lost in S3, such that M₁/M₂ of the resulting Na-containing transition metal oxide becomes 0.97 or more and 1.09 or less. M₁ is the molar amount of Na contained in the Na-containing transition metal oxide, and M₂ is the total molar amount of Ni, Mn, and the element M contained in the Na-containing transition metal oxide. In S2, the mixing ratio of the precursor to the element M source may be adjusted such that M₄/(M₃+M₄) of the resulting Na-containing transition metal oxide becomes greater than 0 and less than 0.12. M₃ is the total molar amount of Ni and Mn contained in the Na-containing transition metal oxide, and M₄ is the molar amount of the element M contained in the Na-containing transition metal oxide. In S2, if the amount of the element M source relative to the precursor is too large, an excessive amount of a different phase (impurity phase) other than the O3 phase is generated in the resulting Na-containing transition metal oxide, making it likely that the capacity will decrease. However, as will be described later, if impurities containing the element M are present in the resulting Na-containing transition metal oxide, they may function as a protective layer when this Na-containing transition metal oxide is used in a battery, suppressing decomposition of the electrolyte solution even at high cathode potentials.

### 2.3 Calcination of Mixture

In S3, the mixture obtained in S2 is calcined to obtain an Na-containing transition metal oxide having an O3 structure. In S3, for example, the mixture may be subjected to a preliminary calcination, followed by a main calcination. The preliminary calcination is optional, and its conditions are not particularly limited. The main calcination in S3 is preferably performed at a low temperature at which an O3 crystal structure can be obtained. As confirmed by the inventors, when the main calcination temperature is 760° C. or more and 850° C. or less, and particularly when it is 760° C. or more and 800° C. or less, the resulting Na-containing transition metal oxide having an O3 structure has well-aligned layers of transition metal elements and reduced cation mixing. The atmosphere for the main calcination is not particularly limited, and may be, for example, an oxygen-containing atmosphere such as air. The duration of the main calcination (i.e., the holding time at the main calcination temperature) is not particularly limited, and may be, for example, 12 hours or more and 48 hours or less, or 15 hours or more and 25 hours or less. In S3, the heating rate up to the preliminary or main calcination temperature and the cooling rate after the main calcination are not particularly limited.

### 3. Battery

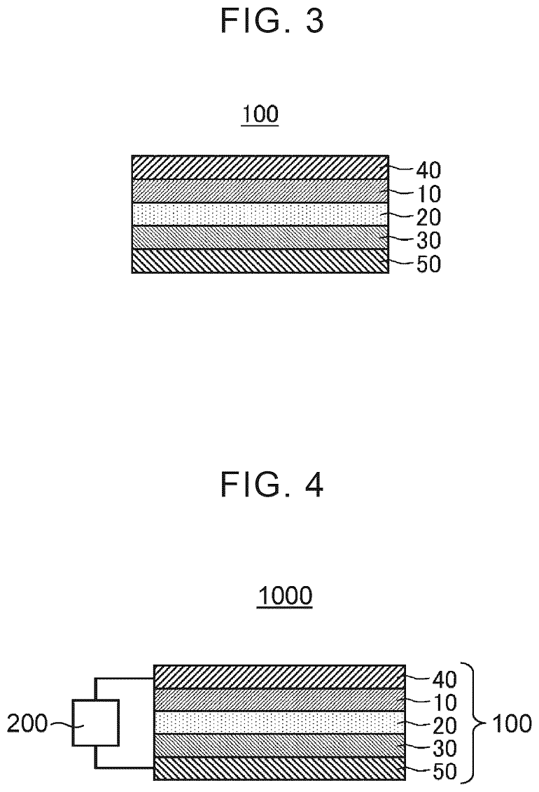

As shown in FIG. 3, a battery 100 according to one embodiment includes a cathode active material layer 10, an electrolyte layer 20, and an anode active material layer 30. The cathode active material layer 10 contains the cathode active material according to the above embodiment.

### 3.1 Cathode Active Material Layer

The cathode active material layer 10 contains at least the cathode active material according to the above embodiment, and may further optionally contain an electrolyte, a conductive additive, a binder, and the like. The cathode active material layer 10 may further contain various additives. The contents of the active material, the electrolyte, the conductive additive, the binder, and the like in the cathode active material layer 10 may be determined as appropriate according to the intended battery performance. For example, when the total amount (total solid content) of the cathode active material layer 10 is taken as 100 mass %, the content of the active material may be 40 mass % or more, 50 mass % or more, or 60 mass % or more, and may be 100 mass % or less or 90 mass % or less. The cathode active material layer 10 is not particularly limited in form and may be, for example, in the form of a sheet having a substantially flat surface. The thickness of the cathode active material layer 10 is not particularly limited, and for example, may be 0.1 μm or more or 1 μm or more, and may be 2 mm or less or 1 mm or less. The cathode active material contained in the cathode active material layer 10 is as described above. The cathode active material may be formed of the above Na-containing transition metal oxide, or may contain other (additional) cathode active materials in addition to the above Na-containing transition metal oxide. From the viewpoint of further enhancing the effects of the technology of the present disclosure, the proportion of the other cathode active materials in the entire cathode active material may be small. For example, when the total amount of the cathode active material is taken as 100 mass %, the content of the above Na-containing transition metal oxide may be 50 mass % or more and 100 mass % or less, 60 mass % or more and 100 mass % or less, 70 mass % or more and 100 mass % or less, 80 mass % or more and 100 mass % or less, 90 mass % or more and 100 mass % or less, 95 mass % or more and 100 mass % or less, or 99 mass % or more and 100 mass % or less. The electrolyte that may be contained in the cathode active material layer 10 may be a solid electrolyte, a liquid electrolyte (electrolyte solution), or a combination thereof. A known solid electrolyte may be used. The solid electrolyte may be an inorganic solid electrolyte or an organic polymer electrolyte. In particular, inorganic solid electrolytes are excellent in ionic conductive properties and heat resistance. The inorganic solid electrolyte may be at least one selected from oxides such as Na₃Zr₂PSi₂O₁₂ and Na₂O-11Al₂O₃; hydrides or borohydrides such as NaBH₄, NaB₁₀H₁₀, NaCB₉H₁₀, NaCB₁₁H₁₂, and NaB₁₂Cl₁₂; sulfides such as Na₃PS₄, Na₃SbS₄, and Na_{2.88}Sb_{0.88}W_{0.12}S₄; and fluorides such as NaPF₆ and NaBF₄. The solid electrolyte may be, for example, in the form of particles. A single type of solid electrolyte may be used alone, or two or more types may be used in combination. The electrolyte solution may contain, for example, sodium ions as carrier ions. The electrolyte solution may be an aqueous electrolyte solution or a non-aqueous electrolyte solution. The composition of the electrolyte solution may be the same as that of known electrolyte solutions for batteries. For example, the electrolyte solution may be a solution in which a sodium salt is dissolved in a carbonate-based solvent at a prescribed concentration. Examples of carbonate-based solvents include fluoroethylene carbonate (FEC), ethylene carbonate (EC), propylene carbonate (PC), diethyl carbonate (DEC), dimethyl carbonate (DMC), and ethyl methyl carbonate (EMC). Examples of sodium salts include NaPF₆, NaClO₄, NaBF₄, NaFSI, NaTFSI, and NaBETI. Examples of conductive additives that may be contained in the cathode active material layer 10 include carbon materials such as vapor-grown carbon fibers (VGCF), acetylene black (AB), Ketjenblack (KB), carbon nanotubes (CNT), and carbon nanofibers (CNF); and metal materials such as nickel, aluminum, and stainless steel. The conductive additive may be, for example, in the form of particles or fibers, and its size is not particularly limited. A single type of conductive additive may be used alone, or two or more types may be used in combination. Examples of binders that may be contained in the cathode active material layer 10 include butadiene rubber (BR)-based binders, butyl rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, and polyimide (PI)-based binders. A single type of binder may be used alone, or two or more types may be used in combination.

### 3.2 Electrolyte Layer

The electrolyte layer 20 contains at least an electrolyte. When the battery 100 is a solid battery (a battery including a solid electrolyte and optionally further including a liquid electrolyte, or an all-solid-state battery including no liquid electrolyte), the electrolyte layer 20 contains a solid electrolyte and may further optionally contain a binder or the like. In this case, the contents of the solid electrolyte and the binder or the like in the electrolyte layer 20 are not particularly limited. On the other hand, when the battery 100 is an electrolyte solution battery, the electrolyte layer 20 contains an electrolyte solution, and may further include a separator or the like for holding the electrolyte solution and inhibiting contact between the cathode active material layer 10 and the anode active material layer 30. The thickness of the electrolyte layer 20 is not particularly limited, and, for example, may be 0.1 μm or more or 1 μm or more, and may be 2 mm or less or 1 mm or less. The electrolyte contained in the electrolyte layer 20 may be selected as appropriate from those exemplified above as electrolytes that may be contained in the cathode active material layer 10. The binder that may be contained in the electrolyte layer 20 may also be selected as appropriate from those exemplified above as binders that may be contained in the cathode active material layer 10. For each of the electrolyte and the binder, a single type may be used alone, or two or more types may be used in combination. The separator may be any separator commonly used in batteries.

### 3.3 Anode Active Material Layer

The anode active material layer 30 contains at least an anode active material, and may further optionally contain an electrolyte, a conductive additive, a binder, and the like. The anode active material layer 30 may further contain various additives. The contents of the anode active material, the electrolyte, the conductive additive, the binder, and the like in the anode active material layer 30 may be determined as appropriate according to the intended battery performance. For example, when the total amount (total solid content) of the anode active material layer 30 is taken as 100 mass %, the content of the anode active material may be 40 mass % or more, 50 mass % or more, or 60 mass % or more, and may be 100 mass % or less or 90 mass % or less. The anode active material layer 30 is not particularly limited in form and may be, for example, in the form of a sheet having a substantially flat surface. The thickness of the anode active material layer 30 is not particularly limited, and for example, may be 0.1 μm or more or 1 μm or more, and may be 2 mm or less or 1 mm or less. As the anode active material, various materials may be used that store and release charge compensation ions at a potential (charge/discharge potential) more negative than that of the above cathode active material. The anode active material may be, for example, an inorganic anode active material such as metallic sodium, an anode active material formed of an organic compound, or a combination thereof. A single type of anode active material may be used alone, or two or more types may be used in combination. The anode active material may be in any form commonly used for anode active materials in batteries. For example, the anode active material may be in the form of particles. The anode active material particles may be primary particles, or may be secondary particles formed by aggregation of a plurality of primary particles. For example, the average particle size (D50) of the anode active material particles may be 1 nm or more, 5 nm or more, or 10 nm or more, and may be 500 μm or less, 100 μm or less, 50 μm or less, or 30 μm or less. Alternatively, the anode active material may be in the form of a sheet (foil, film) such as sodium foil. That is, the anode active material layer 30 may a sheet of the anode active material. Examples of electrolytes that may be contained in the anode active material layer 30 include the above solid electrolytes, electrolyte solutions, and combinations thereof. Examples of conductive additives that may be contained in the anode active material layer 30 include the above carbon materials and metal materials. The binder that may be contained in the anode active material layer 30 may be selected as appropriate from those exemplified above as binders that may be contained in the cathode active material layer 10. For each of the electrolyte and the binder, a single type may be used alone, or two or more types may be used in combination.

### 3.4 Other Matters

As shown in FIG. 3, the battery 100 may include a cathode current collector 40 in contact with the cathode active material layer 10 and an anode current collector 50 in contact with the anode active material layer 30. Any current collector commonly used in batteries may be employed. The battery 100 may further include, in addition to the above components, tabs, terminals, and other components that are commonly provided in batteries. The battery 100 may have the above components housed inside an outer casing. Any known outer casing used for batteries may be employed. A plurality of batteries 100 may be electrically connected and stacked as desired to form a battery assembly. In this case, the battery assembly may be housed in a known battery case. The battery 100 may further include other well-known components such as terminals. Examples of the shape of the battery 100 include a coin type, a laminate type, a cylindrical type, and a prismatic type. As described above, the battery 100 may be a sodium-ion battery. Except for the use of the specific cathode active material described above, the battery 100 can be manufactured by known methods.

### 4. Battery System

The technology of the present disclosure also has an aspect as a battery system. As shown in FIG. 4, a battery system 1000 according to one embodiment includes the battery 100 and a control unit 200. The battery 100 is the battery according to the above embodiment. The control unit 200 controls charging of the battery 100 such that the cathode potential at the charge cutoff potential of the battery 100 becomes 4.0 V or more (vs. Na/Na⁺).

The control unit 200 may be any unit capable of controlling charging and discharging of the battery 100, and its configuration is not particularly limited. The control unit 200 includes known components used to control charging and discharging of the battery 100, and may include, for example, a central processing unit (CPU), a random access memory (RAM), and a read-only memory (ROM). The control unit 200 controls charging of the battery 100 such that the cathode potential at the charge cutoff potential of the battery 100 becomes 4.0 V or more (vs. Na/Na⁺). In conventional batteries, when charging is performed until the cathode potential reaches a high potential of 4.0 V or more (vs. Na/Na⁺), as described above, degradation of the cathode active material occurs, and the cycle characteristics of the battery tend to deteriorate. In contrast, in the battery system 1000 according to the present embodiment, as described above, the crystal structure of the cathode active material included in the battery 100 is stabilized by the element M, resulting in excellent charge-discharge reversibility. Therefore, even when charging is performed until the cathode potential reaches a high potential of 4.0 V or more (vs. Na/Na⁺), deterioration in the cycle characteristics of the battery is less likely to occur. The upper limit of the charge cutoff potential is not particularly limited. For example, the control unit 200 may control charging of the battery 100 such that the cathode potential at the charge cutoff potential of the battery 100 is 4.0 V or more (vs. Na/Na⁺) and 5.0 V or less (vs. Na/Na⁺), 4.0 V or more (vs. Na/Na⁺) and 4.5 V or less (vs. Na/Na⁺), or 4.0 V or more (vs. Na/Na⁺) and 4.2 V or less (vs. Na/Na⁺). As described above, although the control unit 200 controls charging of the battery 100, it may also control discharging of the battery 100 in addition to charging. The discharge cutoff potential of the battery 100 may be determined as appropriate according to the performance etc. of the battery 100 and may be, for example, 2.0 V or more (vs. Na/Na⁺).

Embodiments of the cathode active material and the like have been described. However, the technology of the present disclosure is not limited to the above embodiments, and various modifications may be made without departing from the spirit and scope of the disclosure. Hereinafter, the technology of the present disclosure will be described in further detail with reference to examples. However, the present disclosure is not limited to the following examples.

### 1. Common Conditions for Producing Cathode Active Material

### 1.1 Preparation of Precursor

An aqueous sodium hydroxide solution having a concentration of 8 mol/L was placed in a reaction vessel set to 40° C., and the pH of the solution in the reaction vessel was maintained at 11.5. An aqueous transition metal solution obtained by mixing an aqueous nickel sulfate solution and an aqueous manganese sulfate solution was added dropwise, together with a 28 mass % aqueous ammonia solution, to the solution in the reaction vessel to synthesize a composite hydroxide as a precursor. The synthesized precursor was separated from the filtrate by suction filtration. The precursor was left to stand overnight in a vacuum dryer and then collected.

### 1.2 Preparation of Mixture

The composite hydroxide serving as the precursor, sodium hydroxide serving as the Na source, and an element M source were mixed to obtain a mixture. The mixing ratio of the precursor, the Na source, and the element M source was adjusted such that the molar ratio in the resulting sodium-containing transition metal oxide became Na:Ni:Mn:M=x:y:1-x-z:z.

### 1.3 Calcination of Mixture

The above mixture was placed in an electric furnace and subjected to a preliminary calcination under an atmosphere of air, followed by a main calcination at 800° C. for 20 hours under the same atmosphere. Thereafter, the calcined material was cooled to room temperature and crushed to obtain an Na-containing transition metal oxide for evaluation. In the resulting Na-containing transition metal oxide, a portion of the transition metal was substituted with the element M, and the molar ratio of Ni to Mn slightly varied depending on the type and amount of the element M source used in the above mixture.

### 2. Production Conditions of Cathode Active Materials in Examples and Comparative Examples

### 2.1 Example 1-1

In the common conditions described above, aluminum oxide was used as the element M source, and the mixing ratio of the precursor, the Na source, and the element M source in the mixture was adjusted such that the molar ratio in the resulting sodium-containing transition metal oxide became Na:Ni:Mn:Al=1.02:0.500:0.490:0.010.

### 2.2 Example 1-2

In the common conditions described above, aluminum oxide was used as the element M source, and the mixing ratio of the precursor, the Na source, and the element M source in the mixture was adjusted such that the molar ratio in the resulting sodium-containing transition metal oxide became Na:Ni:Mn:Al=1.02:0.500:0.485:0.015.

### 2.3 Examples 1-3

In the common conditions described above, aluminum oxide was used as the element M source, and the mixing ratio of the precursor, the Na source, and the element M source in the mixture was adjusted such that the molar ratio in the resulting sodium-containing transition metal oxide became Na:Ni:Mn:Al=1.02:0.500:0.400:0.100.

### 2.4 Examples 1-4

In the common conditions described above, aluminum nitrate nonahydrate was used as the element M source, and the mixing ratio of the precursor, the Na source, and the element M source in the mixture was adjusted such that the molar ratio in the resulting sodium-containing transition metal oxide became Na:Ni:Mn:Al=1.04:0.490:0.493:0.017.

### 2.5 Examples 1-5

In the common conditions described above, aluminum nitrate nonahydrate was used as the element M source, and the mixing ratio of the precursor, the Na source, and the element M source in the mixture was adjusted such that the molar ratio in the resulting sodium-containing transition metal oxide became Na:Ni:Mn:Al=1.02:0.500:0.450:0.050.

### 2.6 Examples 1-6

In the common conditions described above, aluminum nitrate nonahydrate was used as the element M source, and the mixing ratio of the precursor, the Na source, and the element M source in the mixture was adjusted such that the molar ratio in the resulting sodium-containing transition metal oxide became Na:Ni:Mn:Al=1.05:0.500:0.390:0.110.

### 2.7 Example 2-1

In the common conditions described above, iron oxide was used as the element M source, and the mixing ratio of the precursor, the Na source, and the element M source in the mixture was adjusted such that the molar ratio in the resulting sodium-containing transition metal oxide became Na:Ni:Mn:Fe=1.08:0.500:0.489:0.011.

### 2.8 Example 2-2

In the common conditions described above, iron oxide was used as the element M source, and the mixing ratio of the precursor, the Na source, and the element M source in the mixture was adjusted such that the molar ratio in the resulting sodium-containing transition metal oxide became Na:Ni:Mn:Fe=1.09:0.500:0.482:0.018.

### 2.9 Example 3-1

In the common conditions described above, magnesium oxide was used as the element M source, and the mixing ratio of the precursor, the Na source, and the element M source in the mixture was adjusted such that the molar ratio in the resulting sodium-containing transition metal oxide became Na:Ni:Mn:Mg=1.08:0.500:0.490:0.010.

### 2.10 Example 4-1

In the common conditions described above, molybdenum oxide was used as the element M source, and the mixing ratio of the precursor, the Na source, and the element M source in the mixture was adjusted such that the molar ratio in the resulting sodium-containing transition metal oxide became Na:Ni:Mn:Mo=1.06:0.500:0.490:0.010.

### 2.11 Comparative Example 1

In the common conditions described above, no element M source was used, and the mixing ratio of the precursor and the Na source in the mixture was adjusted such that the molar ratio in the resulting sodium-containing transition metal oxide became Na:Ni:Mn=1.01:0.500:0.500.

### 2.12 Comparative Example 2

In the common conditions described above, tungsten oxide was used as the element M source, and the mixing ratio of the precursor, the Na source, and the element M source in the mixture was adjusted such that the molar ratio in the resulting sodium-containing transition metal oxide became Na:Ni:Mn:W=1.01:0.500:0.490:0.010.

### 3. Confirmation of Chemical Compositions and Crystal Structures of Cathode Active Materials

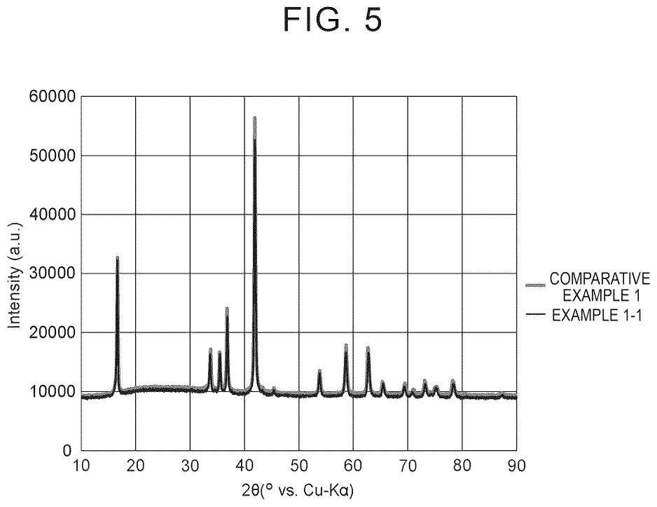

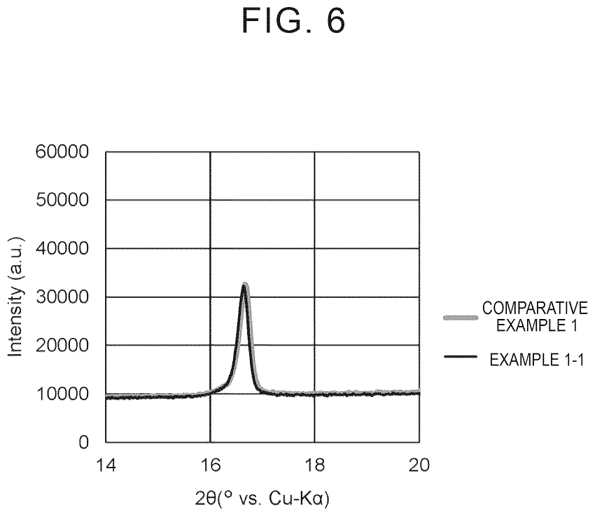

The chemical compositions of the respective Na-containing transition metal oxides obtained as described above were determined. Each of the Na-containing transition metal oxides had the composition shown in Table 1 below. X-ray diffraction patterns were also obtained for each of the Na-containing transition metal oxides, and all of them were found to have an O3 structure. FIGS. 5 and 6 show the X-ray diffraction patterns of the cathode active materials of Example 1-1 and Comparative Example 1. FIG. 6 is an enlarged graph of the diffraction peaks around the (003) plane. As shown in FIGS. 5 and 6, the addition of the element M causes a slight shift in the peak position originating from the (003) plane. This indicates that the element M is present in the transition metal layers of the O3 structure.

TABLE 1

| | Chemical Composition | Crystal Structure |
|---|---|---|
| Example 1-1 | Na_{1.02}Ni_{0.500}Mn_{0.490}Al_{0.010}O₂ | O3 |
| Example 1-2 | Na_{1.02}Ni_{0.500}Mn_{0.485}Al_{0.015}O₂ | O3 |
| Examples 1-3 | Na_{1.02}Ni_{0.500}Mn_{0.400}Al_{0.100}O₂ | O3 |
| Examples 1-4 | Na_{1.04}Ni_{0.490}Mn_{0.493}Al_{0.017}O₂ | O3 |
| Examples 1-5 | Na_{1.02}Ni_{0.500}Mn_{0.450}Al_{0.050}O₂ | O3 |
| Examples 1-6 | Na_{1.05}Ni_{0.500}Mn_{0.390}Al_{0.110}O₂ | O3 |
| Example 2-1 | Na_{1.08}Ni_{0.500}Mn_{0.489}Fe_{0.011}O₂ | O3 |
| Example 2-2 | Na_{1.09}Ni_{0.500}Mn_{0.482}Fe_{0.018}O₂ | O3 |
| Example 3-1 | Na_{1.08}Ni_{0.500}Mn_{0.490}Mg_{0.010}O₂ | O3 |
| Example 4-1 | Na_{1.06}Ni_{0.500}Mn_{0.490}Mo_{0.010}O₂ | O3 |
| Comparative | Na_{1.01}Ni_{0.500}Mn_{0.500}O₂ | O3 |
| Example 1 | | |
| Comparative | Na_{1.01}Ni_{0.500}Mn_{0.490}W_{0.010}O₂ | O3 |
| Example 2 | | |

### 4. Fabrication of Batteries

Each of the cathode active materials, acetylene black (AB) as a conductive additive, and polyvinylidene fluoride (PVdF) as a binder were mixed at a mass ratio of active material:conductive additive:binder=85:10:5 to obtain an electrode mixture. A paste containing the obtained electrode mixture was applied onto an aluminum foil, followed by air drying at 80° C. for 30 minutes to obtain a laminate. The obtained laminate was punched into disks with a diameter of 16 mm, pressed, and vacuum-dried at 120° C. to obtain electrodes for evaluation. 2032-type coin cells were fabricated using the obtained electrodes and metallic sodium. A non-aqueous electrolyte solution containing 1 M NaPF₆ was used as the electrolyte solution. A mixed solvent of ethylene carbonate (EC), dimethyl carbonate (DMC), and ethyl methyl carbonate (EMC) was used as the solvent of the electrolyte solution.

### 5. Charge-Discharge Cycling Tests

Charge-discharge cycling tests were performed on the obtained coin cells in the voltage range of 4.2 V to 2.0 V (vs. Na/Na⁺) at 25° C. Using the first-cycle discharge capacity as a reference value (100), the discharge capacity retention after the second cycle (second-cycle discharge capacity/first-cycle discharge capacity) and the discharge capacity retention after the third cycle (third-cycle discharge capacity/first-cycle discharge capacity) were determined. The C-rate for the charge-discharge cycling tests was set to 0.3 C.

### 6. Evaluation Results

The results of the charge-discharge cycling tests are shown in Table 2 below.

TABLE 2

| | First-Cycle | Second-Cycle | Third-Cycle |
|---|---|---|---|
| | Discharge | Capacity | Capacity |
| | Capacity | Retention | Retention |
| | (mAh/g) | (%) | (%) |
| Example 1-1 | 189.99 | 95.60 | 91.37 |
| Example 1-2 | 183.23 | 95.90 | 91.41 |
| Examples 1-3 | 188.55 | 95.58 | 90.98 |
| Examples 1-4 | 193.75 | 94.88 | 90.17 |
| Examples 1-5 | 185.89 | 96.39 | 92.98 |
| Examples 1-6 | 185.19 | 96.09 | 92.49 |
| Example 2-1 | 193.36 | 95.53 | 91.09 |
| Example 2-2 | 193.20 | 95.13 | 90.19 |
| Example 3-1 | 194.20 | 95.32 | 90.42 |
| Example 4-1 | 192.66 | 94.94 | 89.92 |
| Comparative | 197.27 | 93.30 | 88.91 |
| Example 1 | | | |
| Comparative | 193.14 | 93.87 | 87.98 |
| Example 2 | | | |

As is apparent from the results shown in Table 2, when the Na-containing transition metal oxide having an O3 structure contains the element M in a predetermined amount, the capacity tends to be well maintained even after repeated charge-discharge cycling at a high charge cutoff potential of 4.0 V or more.

In the above examples, Al, Fe, Mg, and Mo are exemplified as the element M. However, the element M is not limited to these. It is considered that the element M should satisfy the following two conditions: (I) the element M hardly contributes to redox, and (II) the element M has an ionic radius that allows it to be doped into the transition metal layers of the O3 structure. For example, an element that hardly contributes to redox and has an ionic radius greater than 0.48 Å and less than 0.60 Å can be used as the element M. In this respect, the element M may be not only Al, Fe, Mg, and Mo, but also Ti, V, Cr, Cu, Zn, Ga, Se, Zr, Sn, Te, Hf, or Re.

From the above results, it can be said that when a cathode active material containing an Na-containing transition metal oxide satisfies the following conditions (A) to (C), the capacity tends to be well maintained even after repeated charge-discharge cycling at a high charge cutoff potential (for example, 4.0 V or more).
(A) The Na-containing transition metal oxide has an O3 structure;
(B) The Na-containing transition metal oxide has a chemical composition represented by NaₓNi_{y}Mn_{(1-y-z)}M_{z}O₂ (0.97≤x≤1.09, 0<y<1.000, and 0<z<0.120); and
(C) M is one or more elements selected from Al, Fe, Mg, Mo, Ti, V, Cr, Cu, Zn, Ga, Se, Zr, Sn, Te, Hf, and Re.

What is claimed is:

1. A cathode active material comprising an Na-containing transition metal oxide, wherein:
the Na-containing transition metal oxide has an O3 structure;
the Na-containing transition metal oxide has a chemical composition represented by 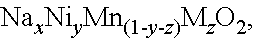
where 0.97≤x≤1.09, 0<y<1.000, and 0<z<0.120; and
M is one or more elements selected from Al, Fe, Mg, Mo, Ti, V, Cr, Cu, Zn, Ga, Se, Zr, Sn, Te, Hf, and Re.

2. The cathode active material according to claim 1, wherein M is one or more elements selected from Al, Fe, Mg, and Mo.

3. The cathode active material according to claim 1, wherein M is one or more elements selected from Al, Fe, and Mg.

4. A battery comprising:
a cathode active material layer;
an electrolyte layer; and
an anode active material layer,
wherein the cathode active material layer contains the cathode active material according to claim 1.

5. A battery system comprising:
a battery; and
a control unit, wherein:
the battery is the battery according to claim 4; and
the control unit is configured to control charging of the battery such that a cathode potential at a charge cutoff potential of the battery becomes 4.0 V or more versus Na/Na⁺.
